(19) United States
(12) Patent Application Publication
(10) Pub. No.: US 2008/0189920 A1
(43) Pub. Date: Aug. 14, 2008

(54) Fastener

(76) Inventor: Marcus Toombs, Suffolk (GB)

Correspondence Address: WOLF GREENFIELD & SACKS, P.C., 600 ATLANTIC AVENUE, BOSTON, MA, 02210-2206, US

(21) Appl. No.: 11/884,159

(22) PCT Filed: Feb. 10, 2006
(86) PCT No.: PCT/GB06/50032

§ 371 Date: Mar. 26, 2008

(30) Foreign Application Priority Data
Feb. 11, 2005 (GB) 0502826.1

(51) Int. Cl. B25B 5/06; F16B 2/12

(52) U.S. Cl. 24/604

(57) ABSTRACT

A fastener (10) for fastening together elongate objects (26), such as scaffolding and other items used in the construction industry, is described. The fastener includes first and second portions (12, 14) which engage with one another by means of male (16) and female (18) members. The first and second portions are relatively rotatable, and may be aligned in a range of positions prior to fastening the device. The male and female members serve to retain the fastener in the closed position, and may use a ratchet arrangement, or may use a friction fastening. Also described is a tool (30) for securing the fastener.

### FIELD OF THE INVENTION

The present invention relates to a fastener, and particularly, but not exclusively, to a fastener for use in the construction industry. Preferred embodiments relate to a fastener for use in fastening scaffold and other framework together. Preferred embodiments of the fastener are suitable for fastening framework together in orientations other than parallel and at right angles to one another, as well as in such orientations. Other embodiments of the invention relate to a tool for securing the fastener.

### BACKGROUND TO THE INVENTION

The construction industry makes significant use of reinforced concrete. Production of this requires the assembly of a steel bar framework within and around which the concrete is poured and allowed to set. The framework is formed from a number of individual steel bars which are fastened together at intersections. It is important when assembling the steel bar framework that the fastenings are secure, and will resist forces which tend to drive the framework apart.

Typically, the framework is fastened together manually, using tie wire. Lengths of wire are wrapped around the bars being joined and tightened by twisting the individual strands together. While this provides a secure fastening, and is flexible in the range of intersection angles and sizes of steel bar which can be accommodated, it is a relatively slow, labour-intensive process.

Attempts have been made to automate the fastening process. For example, devices are known which may be preloaded with lengths of tie wire, which is automatically wrapped around the steel bars and tied. However, such devices are relatively expensive, unreliable and may not suit all applications given the need to access the steel bars at various angles.

It would be advantageous to provide a less complex, more reliable, and less labour-intensive means by which a framework may be connected.

A variety of fastening devices are known from other fields, but these are typically not suitable for use in the construction industry. GB 1 255 078 and GB 2 124 502 both describe surgical clips for occluding blood vessels. U.S. Pat. No. 6,516,498 describes a cable clamp for use in keeping electrical cables together. GB 2 344 133 describes a clip for fastening accessories such as sunshades to a child's pushchair.

### SUMMARY OF THE INVENTION

According to the present invention, there is provided a fastener comprising first and second portions, each portion having an elongate engaging means for engaging with items to be fastened; the fastener further comprising a male member on one portion and a female member on the other portion, the male and female members having interacting means arranged so as to interact to permit the male member to be inserted into the female member on application of force in a first direction thereby bringing the engaging means of the first and second portions towards one another, and to prevent removal of the male member from the female member on application of force in an opposed direction.

Thus the present invention provides a fastener the portions of which may be secured to one another by pushing the two portions together. This means that the fastener is relatively simple and rapid to assemble, and can be fastened to a framework with little difficulty. The fastener resists separation of the portions when force is applied in an opposite direction; this feature is particularly suited to assembly of frameworks, in which the main forces to be resisted are those which tend to pull the framework bars apart, rather than those which push them together. The provision of elongate engaging means is also of significance, as it permits the fastener to be applied to items in substantially any orientation within the plane of the engaging means.

Preferably the male and female members are such that the first and second portions may be oriented in one of a plurality of relative orientations when the members interact. It will be understood that the fastener should be capable of acting as a fastener in each of the orientations. Preferably at least two, and more preferably at least three relative orientations are possible, and in preferred embodiments the first and second portions may be oriented at substantially any angle with respect to one another; in such embodiments certain of the possible orientations may be non-functional as regards the fastener acting as a fastener. The various different orientations are in preferred embodiments within the same plane; for example, the male and female members may have generally cylindrical or otherwise rotationally symmetric forms.

The material from which the fastener is made will be selected according to the application for which it is intended. For example, for the construction industry, metal fasteners may be preferred, while for domestic use, or for uses where strength is not so important, plastic fasteners may be used. For the construction industry, a preferred material is high carbon steel or similar, with a diameter of around 1.5 mm to around 2.5 mm. Alternatively, combinations of materials may be used; for example, the first portion may be of metal, and the second portion may be of plastic. One or both of the portions may be made of sprung steel or a similar material. The sprung steel has the double function of providing tension to the fastener and also resisting the fastened items being pulled apart.

Preferably either or both of the engaging means are curved. The engaging means may be curved to conform to a profile of items to be fastened, for example when the items are steel bars or the like; although this is not essential. The engaging means are preferably curved sufficiently to prevent or restrict unwanted movement of the items to be fastened away from the fastener. For example, the engaging means may be arranged to substantially overlap when the fastener is fully fastened, such that two or more items to be fastened will be effectively contained within a volume defined by the fastener.

In preferred embodiments the first portion includes a curved portion and a straight portion; that is, the first portion has a generally hooked or question mark shaped form. The second portion may be curved, and preferably has a relatively gentle curvature compared with the first portion. In other embodiments, the second portion may be generally straight, or may comprise two or more generally straight sections joined at an angle. The first and/or second portions are preferably shaped to reduce or avoid relative lateral movement of items to be fastened when held by the fastener; this may be achieved, for example, by use of a curved first and/or second portion such that lateral movement of the items to be fastened tends to result in a lateral force back toward the centre or the highest/lowest point of the curved portions. This arrangement is intended to avoid unbalancing of fastened items, and any tendency to open the fastener caused by relative lateral movement of the fastened items.

Either or both of the engaging means may be profiled, to conform to a profile of items to be fastened. For example, where multiple items are to be fastened, each engaging means may carry two or more shaped recesses to accommodate the items.

Either or both of the engaging means may carry a friction-enhancing material, to prevent or reduce slippage of the items to be fastened. For example, the engaging means may include an elastomeric jacket or the like, or may have a rough or otherwise textured surface thereon.

Preferably the male member is elongate. The female member is conveniently in the form of a hollow tube, and may also be elongate. The direction of application of force to assemble the fastener is along the axis of the elongate male member. When assembled, the male member may protrude from the female member; the male member may be designed to be easily cleavable at a point along this protruding portion. For example, the male member may be formed with a weak point or fracture zone along its length. This allows the excess portion of the male member to be removed from the assembled fastener, to reduce the length of excess member. Alternatively, the male member may be formed so as to be cuttable along this length.

Alternatively, the female member may take the form of a bore or hole through the portion of the fastener; in this embodiment the portion having the female member may be of generally planar or plate-like form.

Either or both of the male or female members may include a thermoadhesive or friction-sensitive adhesive coating, whereby heat or friction on the coating causes it to become more adhesive. The heat and friction generated by closing the fastener will activate the adhesive, thereby more securely bonding the two portions of the fastener together. The engaging means are preferably substantially perpendicular to the axis of the male and female members.

Preferably the first and second portions are arranged to permit relative rotation therebetween when assembled. This allows for the relative angles of the two engaging means to be varied, so allowing items at a range of angles to be fastened. This is particularly useful in the context of frameworks, since not all of the bars will meet at right angles. For example, the male and female members may be generally cylindrical, such that the two portions may rotate with respect to one another. The fastener may comprise means for optionally restricting or preventing relative rotation of the portions; for example, a pin or the like may be inserted into aligning holes formed in the male and female members.

In certain embodiments of the invention, however, it may not be desirable to permit relative rotation, and the male and female members may be formed with cooperating profiles which allow engagement thereof in one or a few predetermined positions; for example, the male and female members may be generally square in cross section, thereby allowing only four orientations of the first and second portions.

The interacting means of the male and female members is preferably a ratchet arrangement. The male and female members may be provided with interacting teeth, which permit longitudinal movement in one direction only (rotational movement may still be permitted). The ratchet arrangement may function through temporary deformation of the teeth or of the male or female member, depending on the strength of the materials used to form the fastener. The teeth preferably extend around the perimeter of the male and female members. The teeth are preferably generally triangular in cross section; and more preferably generally right-angled triangular (that is, a first edge of the teeth is generally perpendicular to the axis of the male or female member).

In an alternative embodiment of the invention, the male and female members are provided with corresponding threaded portions, which may be pushed together in the same manner as a ratchet arrangement, but which will additionally permit disengagement of the two portions, if desired, by relative rotation of the portions.

Alternatively the male and female members may take the form of a locking belt of the sort found in cable tie fasteners and the like. A further alternative is provided by a friction fastener, such as that disclosed in relation to a dispensing gun in U.S. Pat. No. 4,072,254. Such a fastener works by deforming the female member around the male member under pressure once the male member has been passed into the female member. As pressure on the fastener is released, the female member will attempt to deflect back to the original position, thereby altering the relative angle between the male and female members and causing a friction lock to form between the two members. This form of fastener has a number of advantages, including the ability to use a single female member for a wide range of different male member sizes, and the ability to eliminate the need for a ratchet fixing if the function fastener is strong enough.

The items to be fastened are preferably elongate items, and may be for example construction bars, rebars, scaffolding, or the like. Alternatively, the items may be cables, pipes, and suchlike. Although the invention has been described with respect primarily to the construction industry, it will be apparent that its uses are not restricted thereto, and fasteners of appropriate size and construction may be useful in a range of situations.

According to a further aspect of the present invention, there is provided a method for fastening items together, the method comprising the steps of:
providing a fastener comprising first and second portions, each portion having an elongate engaging means for engaging with items to be fastened; the fastener further comprising a male member on one portion and a female member on the other portion, the male and female members having interacting means arranged so as to interact to permit the male member to be inserted into the female member on application of force in a first direction thereby bringing the engaging means of the first and second portions towards one another, and to prevent removal of the male member from the female member on application of force in an opposed direction;
locating the fastener around the items to be fastened; and
applying force to the fastener in a first direction to bring the engaging means of the first and second portions towards one another.

The force may be applied manually, or with mechanical assistance, such as a hammer, mallet or the like, or with a vice, pliers, or similar. In certain embodiments, a specialist tool may be provided which is adapted for use with the fastener; for example, a tool may include a pair of jaws shaped to receive the engaging means, with a lever arrangement intended to bring the jaws together in order to close the fastener. Such a tool may be manually or mechanically powered.

The fastener may be provided with the male member partially inserted into the female member, for ease of use and convenience. This also avoids the need for the user to align the portions of the fastener before use, so saving time.

A further aspect of the present invention relates to a tool for securing a fastener, the tool comprising means for retaining a first portion of a fastener, means for retaining a second portion of a fastener, and means for urging the first and second portions towards one another; each portion having an elongate engaging means for engaging with items to be fastened; the fastener further comprising a male member on one portion and a female member on the other portion, the male and female members having interacting means arranged so as to interact to permit the male member to be inserted into the female member on application of force in a first direction thereby bringing the engaging means of the first and second portions towards one another, and to prevent removal of the male member from the female member on application of force in an opposed direction.

The tool may further comprise a magazine for retaining a plurality of first and second portions of fasteners. The tool may also comprise means for transferring a first and a second portion from the magazine to the respective retaining means. In certain embodiments, the magazine may be preloaded with first and second portions.

The means for urging the first and second portions towards one another may comprise a pressure plate, piston, or the like. The urging means may engage with a member provided on the first or second portion. The tool may further comprise means for energizing the urging means; for example, a spring, hydraulic or pneumatic system, an electric motor, and the like. The tool may also comprise means for actuating the urging means, such as a lever, switch, button, trigger, or the like.

The tool may still further comprise means for adjusting the relative angle between the elongate engaging means of the first and second portions of the fastener. Conveniently this is in the form of a wedge, cam, or other biasing member for applying transverse force to the first or second portion of the fastener. In preferred embodiments, the adjustment means comprises a cam surface located adjacent the means for retaining the first or second portion. The cam surface may be rifled or otherwise bored so as to guide the fastener portion in a rotational path. The degree of rotation may be adjusted by rotating the cam surface. In use, this will allow the angle of the fastener to be adjusted on securing the fastener

### BRIEF DESCRIPTION OF THE DRAWINGS

These and other aspects of the present invention will now be described by way of example only and with reference to the accompanying drawings, in which:

FIG. 1 shows a portion of a fastener in accordance with an embodiment of the invention, having a female member;

FIG. 2 shows a portion of a fastener having a male member, for cooperating with the portion of FIG. 1;

FIG. 3 shows the portions of FIGS. 1 and 2 partially assembled;

FIG. 4 shows the fastener of FIGS. 1 to 3 engaged with a pair of framework members in a parallel orientation;

FIG. 5 shows the fastener of FIGS. 1 to 3 engaged with a pair of framework members in a perpendicular orientation;

FIG. 6 shows an overview of a framework connected by means of the fastener of the present invention;

FIG. 7 shows a tool for securing the fastener of FIGS. 1 to 3;

FIGS. 8 and 9 show alternative fasteners in accordance with embodiments of the invention; and

FIGS. 10, 11 and 12 show an alternative tool for securing the fasteners of FIGS. 8 and 9.

### DETAILED DESCRIPTION OF THE DRAWINGS

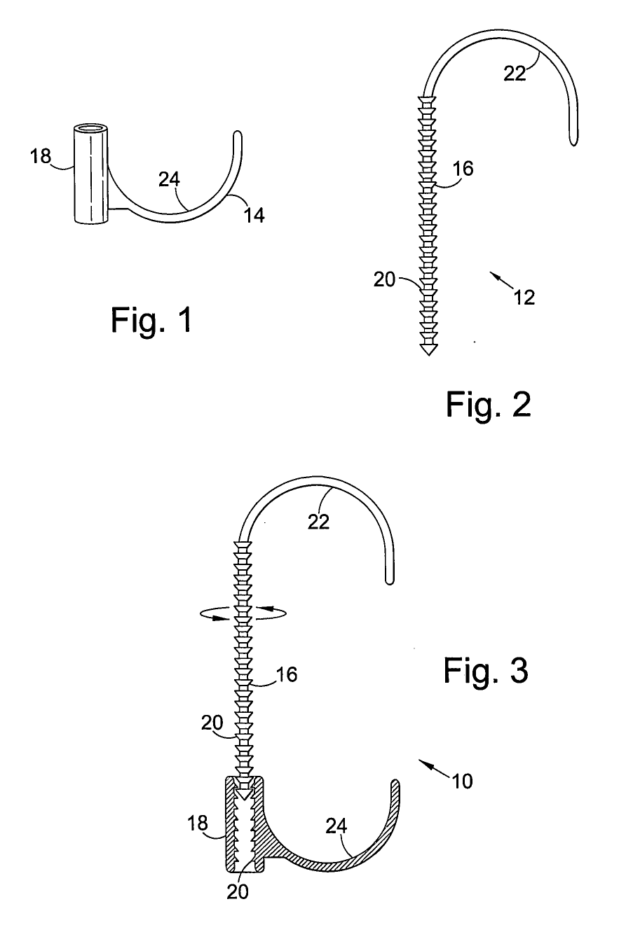

Referring first of all to FIGS. 1 to 3, these show a fastener in accordance with an embodiment of the present invention. The fastener 10 includes two portions 12, 14 which in use engage with one another by means of male 16 and female 18 members. The male member 16 is in the form of an elongate cylinder, while the female member 18 is a shorter hollow cylinder. On both male and female members are provided a number of ratchet teeth 20 in the form of circumferentially-extending rings. The teeth 20 in profile are right angled triangles and orientated such that in use the long edges of the triangles on the male member are facing towards the long edges of the triangles on the female member. The orientation of the teeth will allow the male member to enter the female member when subject to a compressive force along the axis of the male member, but not to return when an opposed force is applied.

Each portion 12, 14 also includes an elongate, curved engagement means 22, 24 extending generally perpendicularly away from the axis male or female portion. The engagement means is designed to engage with and wrap around the items that are to be held together.

As shown in FIG. 3, the fastener may be supplied to users in partially-assembled form, with the male portion 12 partially inserted into the female portion 14. This ensures that both portions are kept together while the fastener is in transit. The ratchet arrangement prevents the male and female portions from becoming disengaged. The cylindrical form of the male and female members 16, 18 allows the two portions 12, 14 of the fastener to rotate relative to one another, such that the engagement means 22, 24 can be aligned in particular positions depending on the items to be fastened.

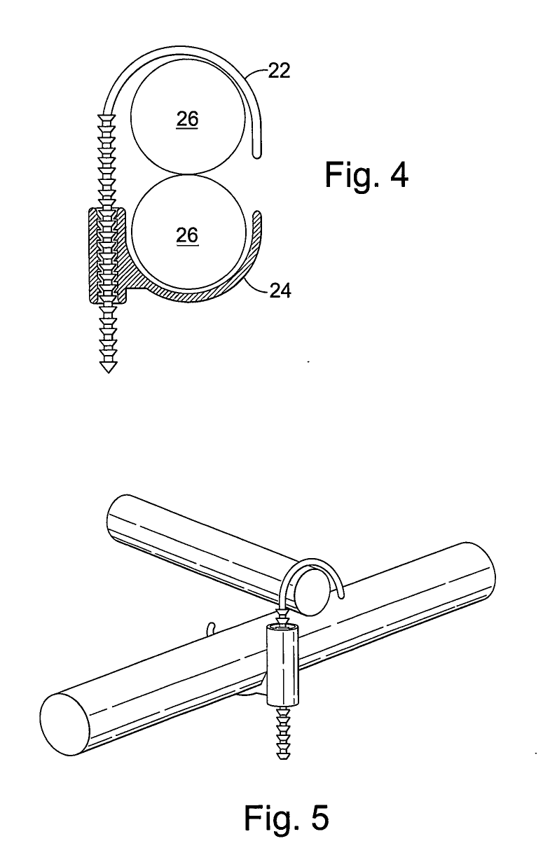

In use, as shown in FIG. 4 the fastener is placed around two or more items 26 to be fastened (in this example, framework members). An axial force is then applied to the two portions to bring them towards one another, and to force the male member through the female member. The curved engagement means 22, 24 then enclose and hold together the two framework members 26, while any forces tending to separate the two portions from one another are resisted by the ratchet arrangement. A portion of the male member will protrude from the end of the female member; this may be formed with a weak point therein, allowing the protruding portion to be severed from the fastener.

The force may be applied by any suitable method, depending on the force needed and the size and nature of the fastener. For example, larger fasteners used in construction may be supplied with a suitable tool for bringing the portions together, while smaller fasteners may be engaged with a mallet or the like, and yet smaller fasteners may be engaged manually.

It will be seen that in this embodiment there is no method of separating the fastener other than by cutting or otherwise breaking the fastener; however, certain embodiments may have the ratchets formed as a screw thread, allowing disengagement of the two portions where desired.

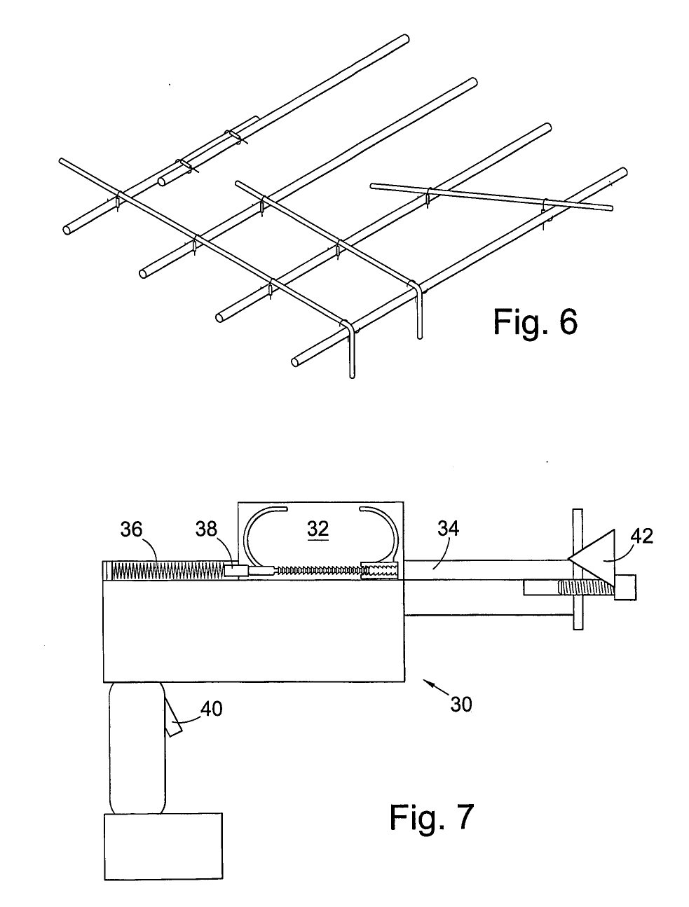

FIG. 5 shows that the fastener may be used to secure frame members at different orientations, simply by altering the relative orientation of the two portions of the fastener. FIG. 6 shows an example of a framework including fasteners at a range of different orientations.

Referring now to FIG. 7, this shows a tool which may be used for securing the fastener as described. The tool 30 includes a magazine 32 which holds a number of first and second fastener members, and a rack 34 into which one first and one second member are loaded. The tool also includes a spring 36 which drives a piston 38 along the rack 34, to urge the first and second fastener portions together. The spring 36 is actuated by a trigger mechanism 40.

Using a spring loaded magazine clip the fasteners are moved sideways on to the rack 34. They are then collected on the first pull of the trigger 40 by a piston 38 and moved forward into the closing position; alternatively a separate trigger mechanism may be used for this step, or the collection may be performed automatically.

The portion of the fastener away from the piston abuts a cam member 42 which acts as an end adjuster. The adjuster causes this portion of the fastener to be swivelled to a desired angle; the angle may be varied by rotating the end adjuster, which is an angled piece of metal.

The fastener is kept in place by the piston 38 until the fastener is closed. Pulling the trigger a second time will close the fastener. Once a certain pressure is achieved the piston 38 is pulled back from the fastener allowing it to be released from the tool.

A modification of the tool described may be a largely manual tool. This is broadly similar, but may include any or all of the following variations:
a) Single fasteners may be loaded directly into the closing position, and no magazine is present.
b) Each fastener may be loaded by pulling a lever back to engage a new fastener and then moving the lever forward to engage the fastener in the closing position.
c) The angle of the male or female unit could be set manually using fingers, rather than the end adjuster.
d) Pulling the trigger will close the fastener. Gears may have to be used to achieve the full closing distance.
e) When the trigger is released the pressure will come off the fastener allowing it to be disengaged from the tool.

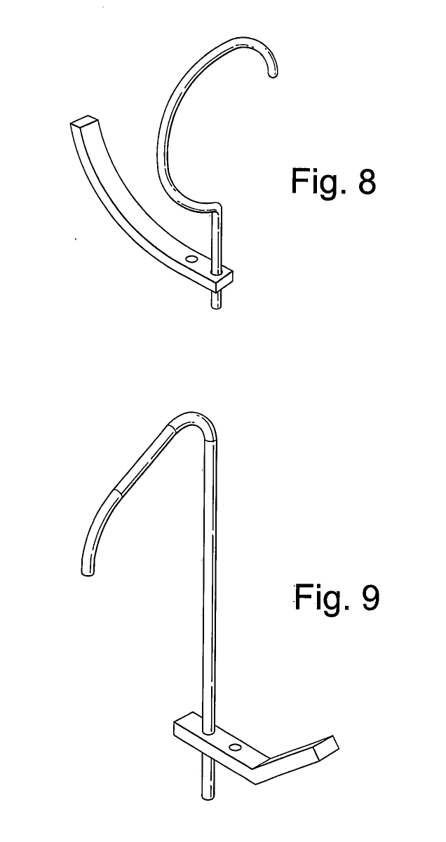

FIG. 8 shows an alternative embodiment of a fastener in accordance with the present invention. The fastener includes a first portion having a generally hook shaped or question mark shaped form, such that the curved region of the fastener extends relatively far around an item to be fastened. The hook shaped form also allows for the highest point on the curve to be located generally above the second portion of the fastener; this arrangement centres the items to be fastened in line with one another, and the curve of the first portion will tend to urge items back towards the centre point when they are subject to relative lateral movement. This improves the reliability of the fastener. The second portion of the fastener is generally plate like in form, and has a more gentle curvature than the first portion.

FIG. 9 shows a still further embodiment of a fastener in accordance with the invention. The first portion has a somewhat different form to that of FIG. 8, while the second portion comprises two generally planar sections joined at an angle. The fasteners of both FIGS. 8 and 9 do not include a ratchet arrangement, but instead rely on a friction fastening; on assembly of the fastener, the second portion is deformed under pressure to urge it towards the first. On release of pressure, the second portion tends to return to its original configuration, thereby altering the relative angles of the first and second portions, and causing the male and female members to lock together by friction. In alternative embodiments, the devices of FIGS. 8 and 9 may also or instead be provided with a ratchet type arrangement. It will be noted that the lower, female portion of the fastener includes two female members, allowing a range of different sizes of construction bars and the like to be fastened together, depending on which female member the male member engages with. More or fewer female members may be present in other embodiments.

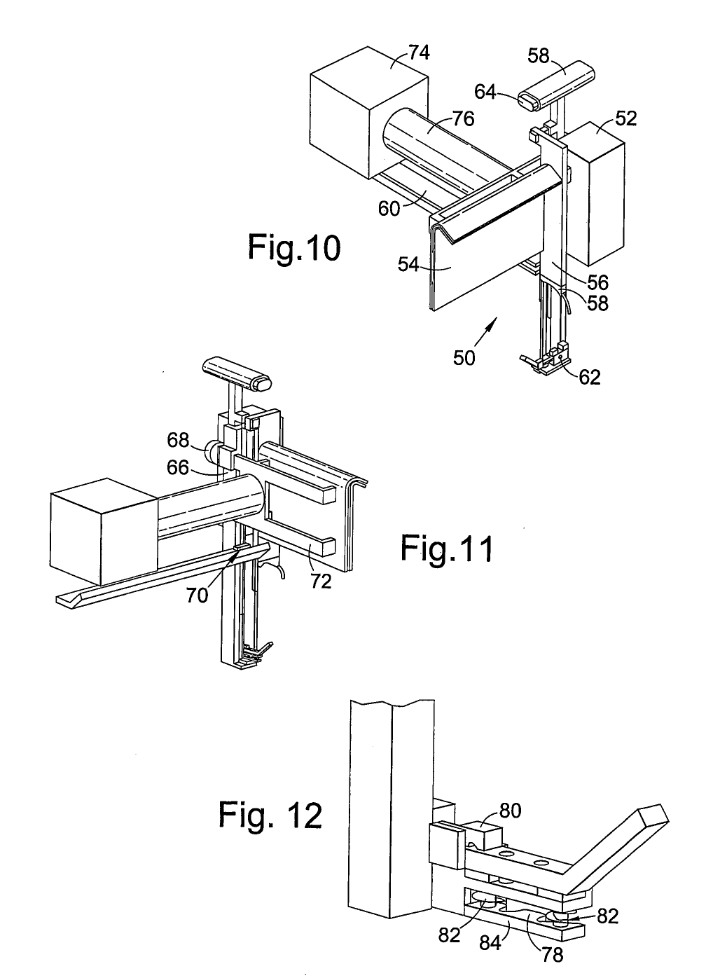

FIGS. 10, 11 and 12 show a tool designed for securing the fasteners of FIGS. 8 and 9 by deforming the second portion. The tool 50 as shown is a semi automatic hand tool, which utilises a manual process to load the next fastener (also referred to herein as a hook) into position and then a battery 74 and a solenoid (contained in the motor housing 52) to close the fastener. A manual or fully automatic tool may be used instead. The tool may be electrically, pneumatically, or hydraulically powered, or may use any other suitable power means. The tool includes male and female hook magazines, a driving pin to collect and bring together portions of the hook, and a swivel head to adjust the relative orientation of the male and female parts of the hook prior to fastening.

The tool 50 includes a male hook magazine 54 formed to the shape of the first, hook-shaped male portion of the fastener, and includes means for loading the hooks and for moving them along inside the magazine (these two items are not shown). A spring or the like may be used.

The male driving pin 56 will prevent the male hooks moving into the loading position until the manual loading pin 58 is fully retracted. At this time the hooks will slide along inside the magazine housing and will stop when they arrive at the back plate of the magazine.

The male hooks may be batched together (in this embodiment 45 per batch) using for example a thin coat of plastic along the head of the hooks. When the male driving pin 56 is moved down into the closing position the male swivel head 58 will cut through this plastic and will jam the male hook in its teeth so holding it in position.

The female hook magazine 60 is again formed into the shape of the female hook and includes means for loading and for moving the hooks along inside the magazine (these two items are not shown). Again the vehicle for this movement may be a spring. At the end of the female magazine 60 there is a sprung steel retaining clip 70 that stops the female clips from falling out at the end of the magazine. As the manual loading pin 58 is moved up to collect the next set of hooks this clip is lifted upwards and the next female hook will move onto and be collected by the female spring housing 62. The female hooks may be batched together similarly to the male hooks, using for example a thin film of tape or paper.

The manual loading pin 58 is the vehicle by which the male and female hooks are collected from their respective magazines 54, 60 and then moved down into the closing position. When the locking button 64 is pressed the manual loading pin 58 can be physically pulled up (in a vertical direction) to collect the hooks from the magazines. The manual loading pin travels in the assembly frame 66 and draws up with it the male driving pin 56 and the female spring housing 62.

As the female spring housing reaches its loading position it pushes up the female magazine spring retaining clip 70 and retains this position to collect the female hook. As the manual loading pin 58 is pulled further up it carries the male driving pin up past the male hook magazine to allow the next male hook to move into position. As the manual loading pin is then moved downwards it collects the male hook and moves it downwards into the hole of the female hook (in this embodiment a distance of 10 mm).

When the manual loading pin 58 continues downwards it then collects the female spring and both the male and the female hooks are moved into the closing position with the male hook partially inserted into the female hook.

The manual loading pin then locks back into the closing position and the fastener is ready for use.

Depending on the size of the items being fixed the adjustment dial 68 may be used to ensure the male hook either enters the first or the second hole in the female hook. For example, if reinforcement scaffolding bars are being fixed, then if the bottom reinforcement bar is a size #3 (⅜″; 95 mm) or a #4 ( 4/8″; 127 mm) then the inner hole will be used. However if the bar size is #5 (⅝″; 159 mm) or a #6 ( 6/8″; 190 mm) then the outer hole will be used. When the adjustment dial 68 is adjusted it will move the male assembly frame 72 (including the male magazine 54, the handle 76, and the battery 74) in relation to the main assembly frame 66. The offset distance between positions in this embodiment is 5 mm.

The male driving pin 56 is used to collect the male hooks and move them into the closing position as previously discussed. The male swivel head 58 is attached to the male driving pin 56 but it can rotate around the axis which passes vertically through the centre of the straight part of the male hook. If two reinforcing bars, or other items being fastened, do not meet perpendicularly to each other then the swivel head 58 can be moved in a clockwise or anti clockwise direction to achieve the required angle.

The part of the swivel head that engages with the top of the male hook in profile is shaped like an upside down ‘U’. As the swivel head makes contact with the male hooks it will cut through the plastic strips that are holding the batch of male hooks together. This will then jam the top of the male unit into the ‘U’ of the swivel head and engage the hook. The plastic strips may include guides to ensure the male hook is collected cleanly each time. The swivel head may be spring loaded so will return to its starting position after the fastener has been closed. In a fully automatic hand tool the swivel head would automatically move to the pre-selected position.

The female spring housing 62 is independently mounted on a driving pin that travels up and down within the main frame. It can be raised or lowered in two ways. The spring housing is shown in more detail in FIG. 12. Firstly it can be raised by the manual loading pin 58 which moves it up to collect the next female hook and then back down to the closing position. Secondly it can be raised by a motor house driving pin. This pin is again located within the main frame and in this configuration is powered by a solenoid found in the motor housing 52. As the motor house driving pin raises the female spring housing the female hook travels up the length of the male hook and this action brings the fastener to close around the items being fixed.

From FIG. 12 it can be seen that the female spring housing 62 is a specialist device that both holds the female hook in place and also locks the hooks once the fastener has been closed to the required tension. The motor house driving pin runs up the main frame to the motor housing 52 but it pulls up under the spring base at the point marked 78 in FIG. 12. This then puts equal pressure at both ends of the flat part of the female hook and moves the female hook up the male hook through one of the holes. In this way the female hook travels up the male hook with the female hook directly perpendicular to the male hook.

As the bent end of the female hook engages the bottom reinforcement bar then it will start to deflect outwards. With further pressure applied the retaining clip 80 will keep the female hook perpendicular and the female hook will continue to move upwards with the bent end of the hook continuing to deflect outwards. As the required tension is achieved in the fastener then the retaining clip will be released. The unequal pressure on the bent end of the female hook will now force the female hook out of a horizontal position and it will no longer be perpendicular to the male hook. This deflection will lock the two parts together and when the motor housing driving pin is retracted the fastener will remain tightly fixed in position. (The purpose of springs 82 and spring plate 84 is to allow the female hook to be deflected with respect to the male hook when the retaining hook is released.)

In this configuration the retaining clip 80 will be operated by a small solenoid that is controlled by a pressure sensor. However it may also be a mechanical clip whereby when suitable pressure in the springs has been reached and they start to collapse the upward movement of the spring base 84 releases the retaining clip.

The retaining clip 80 also has the function of holding the female clip in place when it is collected from the female magazine. In this configuration the solenoid will remain open until a new female hook moves into position and sets off a sensor to close the solenoid. In a mechanised hand tool the process of pulling up oil the manual loading pin would retract this pin and then let it snap shut once the female hook has been moved into place.

In some embodiments the retaining clip 80 may not be necessary during the closing procedure. In this way the female hook would be driven up the male hook with enough force to keep the female hook perpendicular to the male unit and then in releasing the pressure from the motor housing driving pin the pressure in the deflected end of the female hook will automatically lock the two hooks together. In this scenario the retaining clip could just be a spring clip—tough enough to hold the female hook in place but easily snapped out of once the fastener has been closed. Similarly, the springs 82 and spring base 84 may be omitted.

It will be apparent that the foregoing is for illustrative purposes only, and that various modifications or variations may be made to the invention herein described without departing from the scope of the invention. For example, while reference has been made primarily to fasteners for use in the construction industry, other forms of fastener may be appropriate for use in securing cables or the like to one another. Fasteners of the present invention have the advantages of being secure yet relatively simple to use, and inexpensive to produce. Certain embodiments may be fastened manually, and using a single hand; particularly when the fasteners are supplied pre-assembled.

1. A fastener comprising first and second portions, each portion having an elongate engaging means for engaging with items to be fastened; the fastener further comprising a male member on one portion and a female member on the other portion, the male and female members having interacting means arranged so as to interact to permit the male member to be inserted into the female member on application of force in a first direction thereby bringing the engaging means of the first and second portions towards one another, and to prevent removal of the male member from the female member on application of force in an opposed direction; wherein the male and female members are such that the first and second portions may be oriented in one of a plurality of relative orientations when the members interact.

2. The fastener of claim 1, wherein either or both of the engaging means are curved.

3. The fastener of claim 1, wherein either or both of the engaging means are profiled.

4. The fastener of claim 1 wherein the first portion is curved, and the second portion is generally straight or angled.

5. The fastener of claim 1, wherein either or both of the engaging means carries a friction-enhancing material.

6. The fastener of claim 1, wherein the male member is elongate.

7. The fastener of claim 1, wherein the female member is in the form of a hollow tube.

8. The fastener of claim 1 wherein the female member is in the form of a bore or hole through one of the portions of the fastener,

9. The fastener of claim 1 wherein the male member is cleavable at a point along its length.

10. The fastener of claim 1 wherein the first and second portions are arranged to permit relative rotation therebetween when assembled.

11. The fastener of claim 1 wherein the first and second portions are arranged to prevent relative rotation therebetween when assembled.

12. The fastener of claim 1 wherein the fastener is arranged such that the first and second portions may be arranged in substantially any relative rotational orientation when the members interact.

13. The fastener of claim 1 wherein the interacting means of the male and female members is a ratchet arrangement.

14. The fastener of claim 13 wherein the male and female members are provided with interacting teeth, which permit longitudinal movement in one direction only.

15. The fastener of claim 14 wherein the teeth extend around the perimeter of the male and female members.

16. The fastener of claim 14 wherein the teeth are generally triangular in cross section.

17. The fastener of claim 1 wherein the interacting means of the male and female members is a push-on thread arrangement.

18. The fastener of claim 1 wherein the male and female members interact by means of a friction fastening.

19. The fastener of claim 1, for use in fastening elongate items.

20. A method for fastening items together, the method comprising the steps of:
providing a fastener comprising first and second portions, each portion having an elongate engaging means for engaging with items to be fastened; the fastener further comprising a male member on one portion and a female member on the other portion, the male and female members having interacting means arranged so as to interact to permit the male member to be inserted into the female member on application of force in a first direction thereby bringing the engaging means of the first and second portions towards one another, and to prevent removal of the male member from the female member on application of force in an opposed direction;
locating the fastener around the items to be fastened; and
applying force to the fastener in a first direction to bring the engaging means of the first and second portions towards one another.

21. The method of claim 20, wherein the fastener is provided with the male member partially inserted into the female member.

22. A tool having a pair of jaws shaped to receive the engaging means of the fastener of claim 1, with a lever arrangement intended to bring the jaws together in order to close the fastener.

23. A tool for securing a fastener according to claim 1, the tool comprising means for retaining a first portion of a fastener, means for retaining a second portion of a fastener, and means for urging the first and second portions towards one another.

24. The tool of claim 23 further comprising a magazine for retaining a plurality of first and second portions of fasteners.

25. The tool of claim 23 further comprising first and second magazines for retaining a plurality of first and second portions of fasteners respectively.

26. The tool of claim 24 further comprising means for transferring a first and a second portion from the magazine or magazines to the respective retaining means.

27. The tool of claim 24 wherein the magazine or magazines is or are preloaded with first and second portions.

28. The tool of claim 23 wherein the means for urging the first and second portions towards one another comprises a pressure plate, piston, or the like.

29. The tool of claim 23 wherein the urging means engages with a member provided on the first or second portion.

30. The tool of claim 23 further comprising means for energizing the urging means.

31. The tool of claim 23 further comprising means for adjusting the relative angle between the elongate engaging means of the first and second portions of the fastener.
